(19) United States
(12) Patent Application Publication
(10) Pub. No.: US 2004/0199649 A1
(43) Pub. Date: Oct. 7, 2004

(54) System and method to provide interoperability between session initiation protocol and other messaging services

(76) Inventors: Teemu Tarnanen, Espoo (FI); Michael Rooke, Hyvinkaa (FI)

Correspondence Address: Crawford Maunu PLLC, Suite 390, 1270 Northland Drive, St. Paul, MN, 55120, US

(21) Appl. No.: 10/405,049

(22) Filed: Mar. 31, 2003

(51) Int. Cl. G06F 15/16

(52) U.S. Cl. 709/230

(57) ABSTRACT

A system and method is provided that allows alternative messaging routes when Session Initiation Protocol (SIP) message delivery fails. Automatic retry mechanisms are put into place to automatically retry transmission of a failed SIP message. In one embodiment, a mobile terminal having received a failed SIP delivery message, automatically instantiates a Short Message Service (SMS) message delivery. In another embodiment, a Short Message Service Center (SMSC)/SIP proxy instantiates message retry mechanisms based on a previously configured schedule. A legacy SMS device may also initiate an SMS message to the SMSC/SIP proxy, whereby the SMSC/SIP proxy initiates either SMS or SIP retry mechanisms.

### FIELD OF THE INVENTION

This invention relates in general to application messaging in Third Generation (3G) wireless networks, and more particularly, to providing Short Messaging Service (SMS) as a fallback mechanism to ensure proper delivery of Session Initiation Protocol (SIP) messages in 3G wireless networks.

### BACKGROUND OF THE INVENTION

The mobile industry has experienced a period of exceptional growth during the last several years, where mobile voice and simple SMS text messaging provided some of the primary drivers for that growth. As the next generation of mobile network growth evolves, services will be offered, where rich content as well as voice will be transported throughout a combination of mobile and internet environments, using an integrated Internet Protocol (IP) network layer.

Various benefits of using Internet technology for all future communications, i.e., ALL-IP, include the ability to reduce costs and facilitate new mobile services, where service enablers are the basic building blocks for creating the new mobile services. Key service enablers for the future include, for example, Multimedia Messaging Service (MMS), Instant Messaging (IM), Mobile Digital Rights Management (MDRM), etc. SMS, of course, must continue to be supported in legacy systems since so many services offered today use SMS as the enabling technology.

An ALL-IP network enables seamless network integration of different access options, e.g., broadband, mobile Internet, and existing mobile systems, into a single IP layer. As such, all communication services may be carried over a single network infrastructure, thus enabling the integration of voice, data, and multimedia services. Carriers on the ALL-IP networks will glean a number of important benefits as well, including cost savings, scalability, flexibility, efficient network operations, and new revenue opportunities.

The ALL-IP communication system is to be fully compliant with the Third Generation Partnership Project (3GPP) release 5 and 6 standards, with open interfaces and IP Version 6 (IPv6) support. Accordingly, Session Initiation Protocol (SIP) is introduced as a key ingredient in providing support for multimedia services across the Web and Internet domain for IP enabled devices. For a consumer, for example, this means integrated voice, video, and browsing experience in a single call. With SIP, numerous applications can be implemented which combine traditional telephony with messaging and multimedia. In particular, SIP applications and services may be combined in order to complement and supplement each other in order to provide a more fulfilling and reduced workload experience for the consumer. As applications and services become integrated, they each become readily available to supplement each other's shortcomings.

In particular, the shortcomings of an application or protocol used within the SIP enabled, ALL-IP network may be cured through the use of other services made available by SIP. SIP, for example, allows direct communication between two, Third Generation (3G) terminals to send, e.g., free form text messages between the two 3G terminals. According to 3G, Release 5 (Rel5) or Release 6 (Rel6) specifications, however, if the SIP transaction fails, i.e., the text message cannot be delivered, there is no automatic fall back mechanism currently in place for an automatic retry. Consequently, the consumer in a Rel5 or Rel6 3G network, must manually resend a text message upon the initial failure of SIP to deliver the message. This condition results in a negative experience by the consumer because the consumer has become accustomed to reliable delivery mechanisms previously supported by legacy systems, such as for example, the Short Messaging Service (SMS).

Accordingly, there is a need in the communications industry for a system and method that facilitates a value added mixing of applications, services, and protocols to provide the consumer with increasingly reliable communications.

### SUMMARY OF THE INVENTION

To overcome limitations in the prior art, and to overcome other limitations that will become apparent upon reading and understanding the present specification, the present invention discloses a system and method for providing fallback mechanisms for failed SIP (or other similar communication protocol) message delivery attempts.

In accordance with one embodiment of the invention, a method is provided for retrying or otherwise recommunicating a failed message delivery attempt. The method includes transmitting a message of a first protocol type via a first transmission path. An indication of a failed delivery of the message is received, and the message of the first protocol type is converted to a message of a second protocol type. The message of the second protocol type is then transmitted via a second transmission path.

In accordance with more particular embodiments of such a method, transmitting the message having the first protocol type involves resolving addresses of one or more relay network elements along the first transmission path, and maintaining a record of the resolved addresses. The indication of the failed message delivery may use the record of resolved addresses to traverse the first transmission path. In another embodiment of the method, converting the first protocol type message includes transferring a portion of the resolved addresses from the first protocol type message to a header of the second protocol type, and transferring a message content from the first protocol type message to a message content of the second protocol type. In other particular embodiments of such a method, transmission attempts of the message of the second protocol type occur until delivery is successful, or until a predetermined number of retries has occurred. In other particular embodiments of such a method, the first protocol type may include Session Initiation Protocol (SIP), and the second protocol type may include a protocol consistent with Short Messaging Service (SMS).

In accordance with another embodiment of the invention, a messaging system is provided, which includes at least a first terminal coupled to transmit a message in a first format and network elements coupled to relay the message. One or more second terminals may be coupled to receive the message, where a failed attempt to receive the message causes a retransmission of the message in a second format.

In more particular embodiments of such a system, the first terminal may include a Session Initiation Protocol (SIP) stack as a primary means of communicating messages in the first format, and a Short Messaging Service (SMS) stack as a secondary means of communicating messages in the second format. In a more particular embodiment, receipt of the failed message attempt in the first format causes the first terminal to retransmit the message in the second format. In accordance with another particular embodiment of such a system, at least one of the plurality of network elements includes a Session Initiation Protocol (SIP) stack as a primary means of communicating messages in the first format, and a Short Messaging Stack (SMS) as a secondary means of communicating messages in the second format. In a more particular embodiment, receipt of the failed message attempt in the first format causes one of the network elements to retransmit the message in the second format.

In accordance with another embodiment of the invention, a mobile terminal is provided, where the mobile terminal is wirelessly coupled to a network that includes a network element capable of relaying messages. The mobile terminal includes a memory capable of storing at least one of a protocol module and a legacy module, a processor coupled to the memory and configured by the protocol module to enable a message exchange of a first protocol type with the network element, and a transceiver configured to facilitate the message exchange with the network element. The processor is configured by the legacy module to exchange messages of a second protocol type in response to a failure of exchanges of messages of the first protocol type.

In accordance with another embodiment of the invention, a server operable on a network is used to facilitate an exchange of messages. The server includes various arrangements for receiving messages of a first protocol type, transmitting the messages to a network element, receiving a receipt failure notification from the network element, converting the first protocol type to a second protocol type in response to the receipt of failure notification, and transmitting messages of the second protocol type to the network element.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates and exemplary system architecture in accordance with the present invention;

FIG. 2 illustrates an IP based protocol stack utilized by the system architecture of FIG. 1;

FIG. 3 illustrates an exemplary SIP/SMSC network according to the principles of the present invention;

FIG. 4 illustrates an address resolution message flow diagram;

FIG. 5 illustrates an exemplary message flow diagram in accordance with the principles of the present invention;

FIG. 6 illustrates an alternative message flow diagram in accordance with the principles of the present invention;

FIG. 7 illustrates a representative mobile computing arrangement suitable for initiating messaging retries in accordance with the present invention; and

FIG. 8 is a representative computing system capable of carrying out SMS/SIP proxy functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a method and system that provides a generic mechanism to ensure that a SIP message from an ALL-IP terminal can be delivered reliably to another SIP terminal or legacy messaging terminal. The generic mechanism is one that is enabled by SIP in both the terminal and supporting procedures in the ALL-IP network infrastructure. In particular, a fall back mechanism is enabled such that when a SIP message bound for a specific destination fails to be delivered, a seamless and graceful transition to the fall back mechanism is utilized to perform automatic retransmission of the SIP message. The fall back mechanism may, for example, be implemented with a legacy service such as the SMS service which remains available in 3G, ALL-IP, Rel5 and Rel6 networks. It should be noted that although SMS messaging is presented herein as being the primary fall back mechanism for failed SIP message deliveries, other mechanisms also exist to perform the same function. Mechanisms such as the Multimedia Message Service (MMS), the Enhanced Message Service (EMS), or Instant Messaging (IM) may also provide backup message delivery systems in accordance with the present invention.

A session initiated by SIP generally uses a combination of media such as speech, audio and video streams, but the session may also contain shared applications such as whiteboard or text messages. Even network gaming sessions may be setup by SIP as long as all of the participating applications understand the required parameters for the game. SIP is especially advantageous when a variety of protocols and mechanisms are required in support of a particular session. In particular, Voice over IP (VoIP) requires session setup signaling between two User Agents (UA); a transport such as Real-time Transport Protocol (RTP) to carry the actual voice payload; and control such as the RTP Control Protocol (RTCP) to monitor the quality of the service and to generate reports to the network, all of which may be successfully handled in a SIP message exchange.

SIP is an emerging Internet Engineering Task Force (IETF) standard for setting up multimedia sessions within the ALL-IP network. SIP's basic capabilities are setup, modification, and teardown of any communications session and are, therefore, considered to be a true signaling protocol. SIP also provides personal mobility, meaning that a consumer is reachable via a single address regardless of his current point of attachment to the network. SIP is suitable for combined services because it borrows many features from the HyperText Transfer Protocol (HTTP) and the Simple Mail Transfer Protocol (SMTP), which are currently widely used on the Internet for Web browsing and e-mail, respectively. SIP is designed to be the call state control protocol to be used for call setup and teardown signaling within the 3G ALL-IP system architecture.

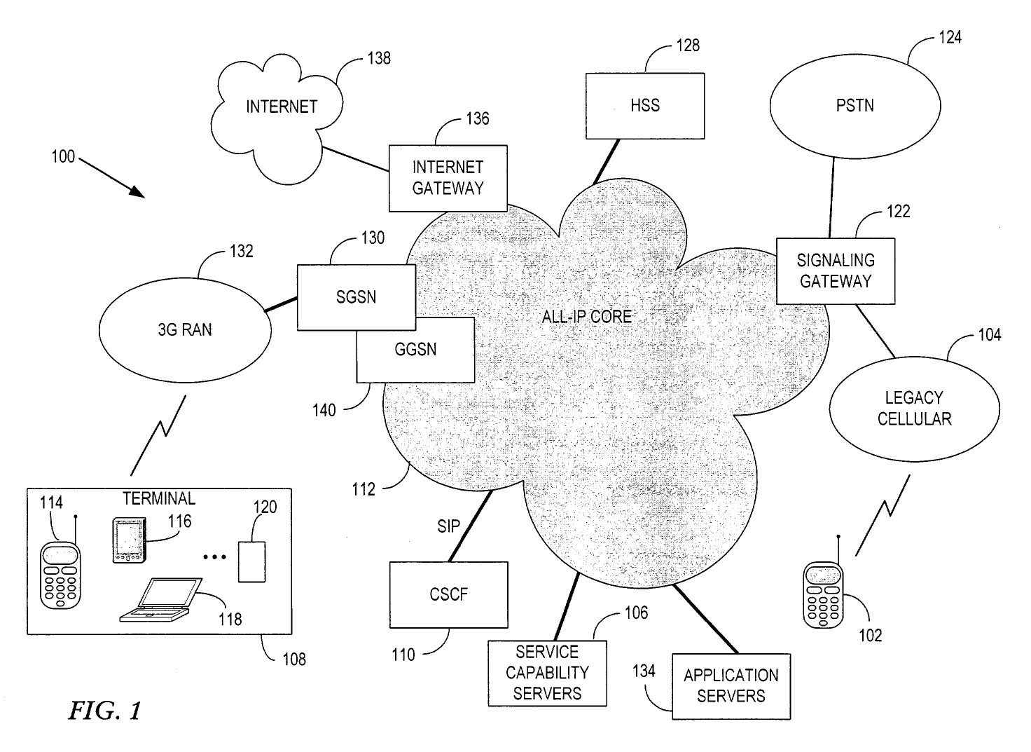

An exemplary system level diagram of ALL-IP system 100 architecture in accordance with the present invention is shown in FIG. 1. ALL-IP core 112 provides the common, IP based signaling core utilized by system 100 to integrate various fixed, mobile, and Internet networks. ALL-IP core 112 allows all communication services to be carried over a single network infrastructure, thus enabling the integration of voice, data, and multimedia services. Further, ALL-IP core 112 allows network resources to be used more efficiently, where increased capacity may be deployed as necessary to meet demand.

ALL-IP system 100 is optimized to support multimedia services, where Call State Control Function (CSCF) 110 implementing SIP is a key ingredient in providing the multimedia services to all IP enabled devices. Although SIP's primary objective was meant for multimedia sessions, its scope may be extended to presence, gaming, and IM, as well. Numerous applications can be implemented using SIP, allowing the combination of traditional telephony with messaging and multimedia. For example, SIP can enhance the concept of caller identification from one of simply displaying the number of the calling party to terminal 108, for example, to one of rich content identification. The calling party may, for example, display his personalized logo or business card information to terminal 108 and deliver the subject of the pending call in text, video, or picture format, depending upon the capabilities of terminal 108.

The wireless terminal 108 may represent any of a number of ALL-IP mobile communication devices, such as a cellular telephone 114, a personal digital assistant (PDA) 116, a notebook or laptop computer 118, or any other type of ALL-IP wireless terminal represented by device 120. 3G Radio Access Network (RAN) 132 represents a combination of all mobile radio standards, such as Global System for Mobile Communications (GSM)/Enhanced Data Rates for Global Evolution (EDGE), Wideband Code Division Multiple Access (WCDMA), and Wireless Local Area Network (WLAN). Each mobile radio standard having its own distinct network architectures and transport mechanisms that are fully integrated using the IP protocol, where Serving General Packet Radio Service (GPRS) Support Node (SGSN) 130 and Gateway GPRS Support Node 140 provides the RAN interface to ALL-IP core 112.

ALL-IP system 100 supports Legacy Cellular systems 104 that offers communication support to non ALL-IP terminal 102, for example. Signaling gateway 122 performs all necessary Signaling System No. 7 (SS7) and Mobile Application Part (MAP) signaling conversions as necessary to provide SS7 over IP access from PSTN 124 and MAP over IP access from Legacy Cellular system 104 to ALL-IP core 112. In addition, signaling gateway 122 provides Short Message Service Center (SMSC) support and Multimedia Message Service Center (MMSC) support for any SMS and MMS operations as required by mobile terminal 102.

Internet 138 access from ALL-IP core 112 is provided through internet gateway 136 to allow accesses defined by Uniform Resource Locator (URL) and Uniform Resource Identifier (URI) address definitions. Home Subscriber Server 128 provides ALL-IP core 112 with the many database functions that are required in ALL-IP networks. HSS 128, for example, includes for example Home Location Register (HLR), Domain Name Server (DNS), network access, and security data bases.

Service capability servers 106 and application servers 134 provide consumer applications and services that are not easily provided within the circuit switched or packet core networks by themselves. Service groups having major relevance in 3G ALL-IP networks include information and entertainment content providers, communication, productivity enhancing services and business solutions. Accordingly, services that are timely, personalized, simple to complete, and location specific are provided to all consumers of ALL-IP system 100.

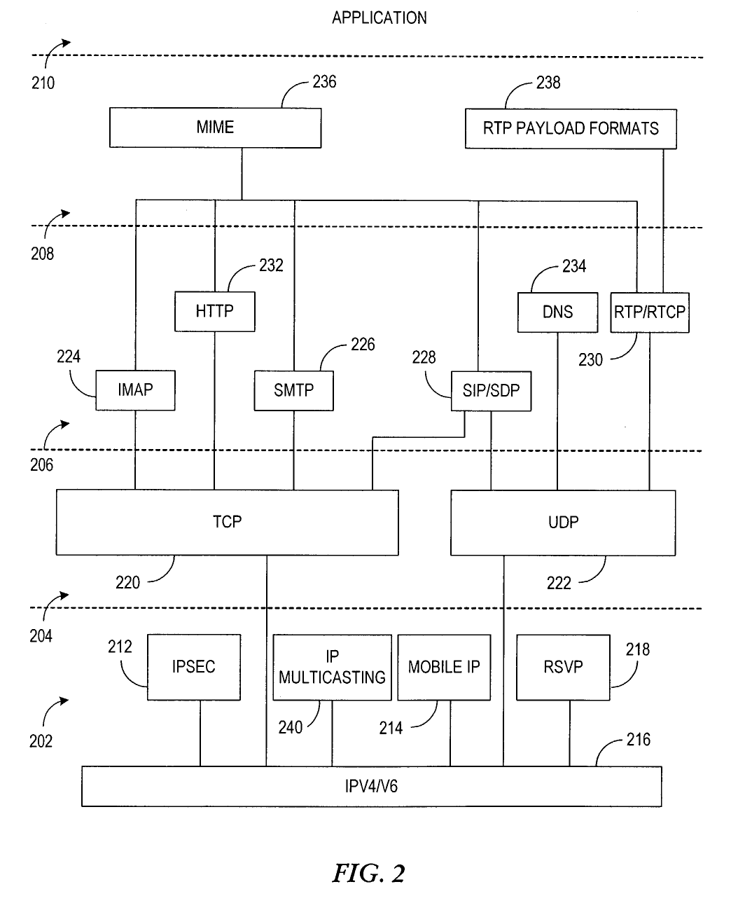

SIP enabled call control within ALL-IP system 100 is provided by CSCF 110, where SIP is hierarchically located in the session layer of the Open System Integration (OSI) model of protocol stack communication. FIG. 2 illustrates SIP and related protocols as they are hierarchically related within the Internet Multimedia Architecture (IMA) as defined by the IETF. Internet layer 202 resides at the bottom of the IMA layered protocol stack above the physical layer (not shown). A portion of Internet layer 202 is comprised of IP layer 216, e.g., IPv4 or IPv6, which runs over every network technology and provides the basic connectionless, packet delivery service for any layer above it. Included with the IP layer is a mobility mechanism, Mobile IP 214, which allows mobile terminals to move freely between different mobile networks. Mobile IP 214 hides the changes in the point-of-attachment to the network from the layers above. Mobile IP 214 also enables mobile devices to receive IP packets via their home networks regardless of which network they happen to be roaming in at the time.

A multicasting agent, IP Multicasting 240, also resides within the IP layer which allows, for example, a mobile subscriber to deliver a packet simultaneously to multiple receivers, easing the scalability of large conferences or media streaming. Security is also provided within the IP layer, i.e., IPSec 212, which provides confidentiality and integrity protection for all traffic. RSVP 218 is a signaling protocol for flow state establishment. A flow is a stream of packets classified by a flow classifier where each packet is subject to a queuing policy. Each packet may be considered individually, for example, to check their conformance to the bandwidth limit associated with each packet in the packet stream.

Above the IP layer resides transport protocol layer 204, which operates end-to-end between hosts or terminals. Exemplary transport protocols include Transmission Control Protocol (TCP) 220 that allows connection-oriented reliable delivery with congestion control and retransmission for data recovery. Another transport protocol is User Datagram Protocol (UDP) 222, which allows a connectionless datagram service where connection setup is not needed or when overhead should be reduced. Another transport within transport layer 204 is the Stream Control Transmission Protocol (SCTP) (not shown) which provides connection-oriented service to multiple interfaces/IP addresses. SCTP allows multiple streams to avoid head of line blocking and is also message oriented, so that protocols running on top of SCTP do not need to worry about message alignment.

Above transport protocol layer 204 resides session protocol layer 206. HTTP 232 performs session control for browsing and enables management of transport layer connections for content transfer. The connections are addressed either to a proxy HTTP server or directly to the server identified by the host part of the Uniform Resource Locator (URL). E-mail type store and retrieve messaging sessions are managed with Simple Mail Transfer Protocol (SMTP) 226 and the Internet Message Access Protocol (IMAP) 224. Layers above transport layer 204 can utilize the Internet Domain Name System (DNS) to translate mnemonic names to numeric addresses required by those layers. Voice and other multimedia content, such as video or animation for example, are transported by RTP/RTCP 230, which runs on top of UDP transport 222. RTP/RTCP 230 also offers synchronization of data streams it carries by including a sequence number and a timestamp header.

Session Initiation Protocol/Session Description Protocol (SIP/SDP) 228 are utilized for instant messaging and rich call session control. SIP/SDP 228 facilitates end-to-end capability negotiation for real-time multimedia communication sessions, where the real-time media is transported over RTP with the aid of RTP/RTCP 230. Addressing for SIP sessions is based on the SIP URLs. SIP user agents are reachable through their registration to the rich session control element in the home network, which is identified by the domain portion of the consumer's SIP URL. Real time transport resources are managed independently by each session participant for his or her own access network.

Presentation layer 208 comprises Multipurpose Internet Mail Extensions (MIME) 236, which defines the rules for labeling and transmission of different data types within SMTP messages and their attachments. MIME 236 also forms the basis for the transmission of streaming data, such as audio and video messages. RTP Payload Formats 238 supports grouping of payload types for specific applications, such as for audio/video conferencing. Payload types identify specific codecs, such as for Moving Pictures Expert Group Version 4 (MPEG-4) streams, or Enhanced Variable Rate Codec (EVRC) speech. Application layer 210 is situated on top of the transport and session layer protocols, providing the various mobile applications with basic application domain independent services, such as user interface, application inter-working, and service access security.

SIP enabled devices utilizing the protocols of FIG. 2 may engage in direct communication to send, for example, free form text messages between them. According to 3G Rel5 or Rel6 specifications, however, if the SIP transaction fails and the text message cannot be delivered, there is no fall back mechanism used to automatically retry message transmission until successful. In particular, SIP messages may be carried by any transport layer IP protocol, including TCP 220 and UDP 222 of FIG. 2. When TCP 220 is used, for example, a TCP connection is first opened between the user agent and the next hop, and the SIP message is then transmitted. If the TCP connection closes during a pending transaction, however, another TCP connection must be opened to either send another INVITE signal or a BYE signal, for example, to close the connection.

In one embodiment according to the principles of the present invention, SMS messaging is utilized to seamlessly provide an alternate delivery route, obviating the need for the user to manually reopen a TCP connection. Rather, an SMSC is utilized to store the free form text message previously attempted via SIP transfer and is then subsequently delivered to the intended recipient. It should be noted that although SMS messaging is presented herein as being the primary fall back mechanism for failed SIP message deliveries, other mechanisms also exist to perform the same function. Mechanisms such as the Multimedia Message Service (MMS), the Enhanced Message Service (EMS), or Instant Messaging (IM) may also provide backup message delivery systems in accordance with the present invention.

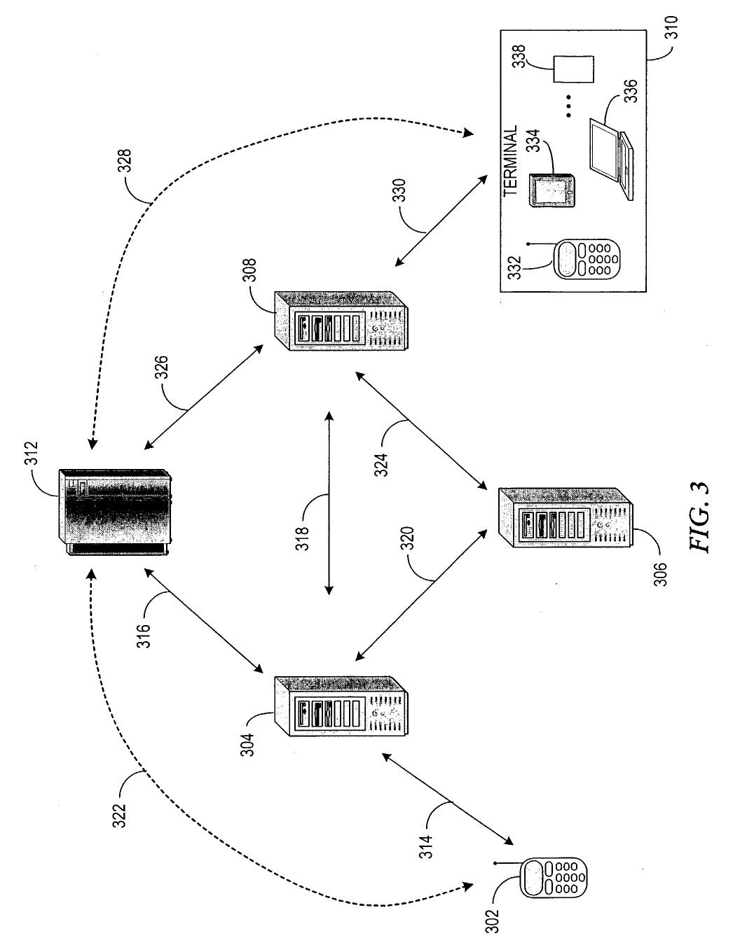

FIG. 3 illustrates an exemplary SIP/SMSC network according to the principles of the present invention to provide an alternate delivery route of a SIP message. Elements of a SIP/SMSC enabled network include user agents, e.g. mobile terminal 302 and mobile terminal 310, SIP servers 304 and 308, location server 306, and SMSC 312. Mobile terminal 310 may be comprised of any one of a mobile phone 332, PDA 334, laptop computer 336, or other mobile device 338. User agents are the end devices in a SIP network and they originate SIP requests to establish media sessions to send and receive media. A user agent may also be a gateway to another network, such as signaling gateway 122 of FIG. 1. Each user agent comprises a user agent client that initiates requests and a user agent server that generates the responses to the requests. SMSC 312 is arranged to communicate to SIP servers 304 and 308, via paths 316 and 326, in the event a SIP message delivery attempt fails. In such a case, SMS signaling paths 322 and 328 are then used to complete the message delivery.

SIP servers 304 and 308 are servers that assist user agents in session establishment and other functions. SIP servers may represent a SIP proxy that receives SIP requests from a user agent, via paths 314 or 330, or another proxy, via path 318, and forwards the request to another location. SIP servers may also represent a redirect server that receives a request from a user agent or proxy and returns a redirection response, e.g., 300, indicating where the request should be retried. SIP servers may also represent a registrar server that receives SIP registration requests and updates the user agent's information into a location server, e.g., 306, or other database, via paths 320 or 324.

SIP servers 304 and 308 may be located by any number of different methods executed by their respective user agents. User agents 302 and 310, for example, may be configured with IP addresses of a primary and a secondary SIP proxy server in much the same way that a web browser contains a default web page that it loads upon initialization. Alternately, SIP servers may be found using a DNS lookup, in which a domain name from a SIP URL is extracted and the IP address of the proxy server that supports that domain is found. A SIP registrar server may be found using IP multicast, supported by IP Multicast 240 of FIG. 2 for example, in which case the SIP registrar server simply listens at a well known SIP multicast address for inbound registrations.

SIP address resolution is one of the most important functions of the SIP protocol because resolution of any URI, or other identifying number of a SIP message recipient, results in the IP address for the SIP message recipient. Resolution of a general name to a specific IP address automatically incorporates mobility and portability functions. In general, address resolution utilizes multiple steps and multiple SIP message hops, where each proxy consults a location server and modifies the request URI accordingly, then forwards the request to the next hop, until the request ultimately is delivered to the desired destination. The response to the request does not involve address resolution, since the response is routed back through the same path as was used by the request through use of the Via header chain in the request message.

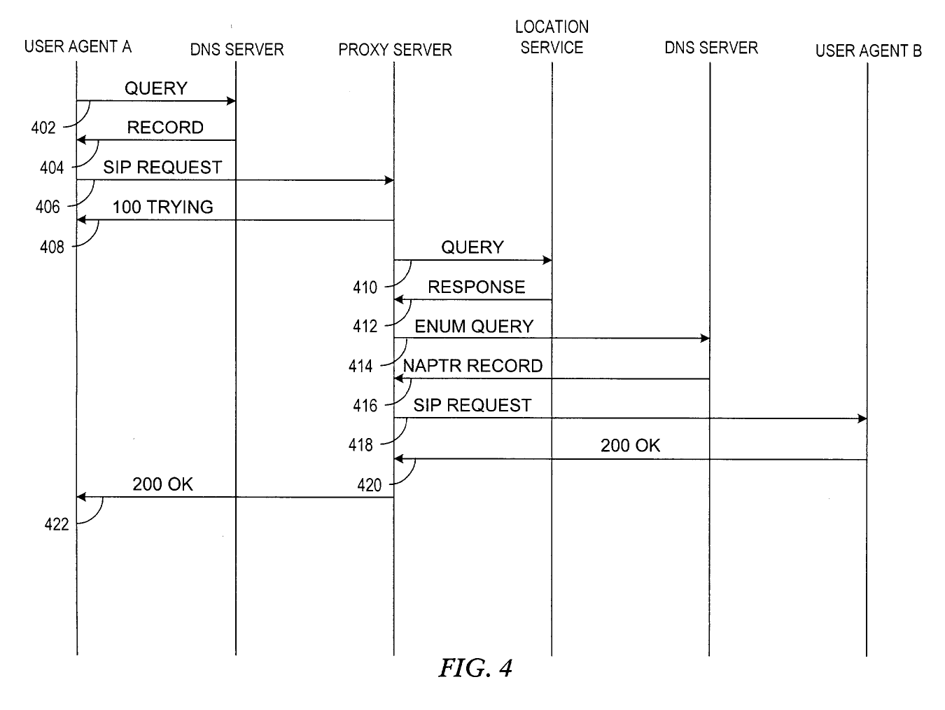

FIG. 4 illustrates an exemplary address resolution request using a location server and DNS lookup and is discussed in relation to FIGS. 1 and 3. User agent A, e.g., mobile terminal 302, wishes to send a general SIP request to user agent B, e.g., laptop computer 336 identified by SIP URL “sip:userB@domain.com”. Mobile terminal 302 first sends DNS SRV query message 402 to locate proxy server 308 that is serving the “domain.com” domain of laptop computer 336. The DNS server that is utilized may be a DNS server located, for example, within HSS 128. The SRV record is returned in message 404 containing the proxy server name for proxy server 308 which is “sipproxyB.domain.com” and its associated IP address.

The SIP request is then sent to the IP address for “sipproxyB.domain.com” in message 406, which is then answered by “100 TRYING” message 408 indicating that the request is progressing, but not yet complete. Location server 306 receives DNS SRV query message 410 from proxy server 308 to which location server 306 then responds with the current registration URL for lap top computer 3336, which is for example “tel:95123456789”, in message 412. Proxy server 308 then sends a DNS ENUM query with the current registration URL, “tel:95123456789”, to the DNS server residing within HSS 128 in message 414. A Naming Authority Pointer (NAPTR) record is then returned from the DNS server in message 416 containing the IP address for lap top computer 336, which is, for example, “sip:UserB@100.101.102.103”. The SIP request is then transmitted to lap top computer 336 in message 418 by proxy server 308 using the IP address “sip:UserB@100.101.102.103”. Message “200 OK” is then transmitted from lap top computer 336 to proxy server 308 in message 420, where it is then forwarded back to mobile terminal 302 in message 422. The results of this initial address resolution may then be cached and used in future requests, or methods, between user agents 302 and 336.

In particular, if mobile terminal 302 wishes to send lap top computer 336 instant message “Watson, come here.”, then the SIP message of Table 1 results.

TABLE 1

| LINE | DESCRIPTION |
|---|---|
| MESSAGE sip: userB@domain.com SIP/2.0 | Method = MESSAGE; |
| | SIP URI = sip: userB@domain.com |
| | SIP Version = 2.0 |
| Via: SIP/2.0/TCP userA@domain.com | Originator = userA@domain.com at port |
| 5060; | 5060 |
| branch = sipproxyA.domain.com 5061; | Forwarding server = |
| branch = sipproxyB.domain.com 5062. | sipproxyA.domain.com at port 5061; |
| | Forwarding server = sipproxyB.domain.com |
| | at port 5062 |
| To: User B | Display Name = User B |
| <sip: userB@domain.com> | Destination URL = <userB@domain.com> |
| From: User A | Display Name = User A |
| <sip: userA@domain.com> | Origination URL = <userA@domain.com> |
| Call-ID: asd88asd77a@1.2.3.4 | Unique Identifier = asd88asd77a |
| | Globally Unique IP Address = 1.2.3.4 |
| CSeq: 1 MESSAGE | Command Sequence Number = 1 |
| | Request Method = MESSAGE |
| Content-Type: text/plain | Content Type = plain text |
| Content-Length: 18 | Content Length = 18 |
| Watson, come here. | Message = “Watson, come here.” |

The message of Table 1 exemplifies the fact that mobile terminal 302 and lap top computer 336 are both SIP enabled devices, in which an instant message was successfully communicated via SIP.

The first line of the SIP message shown in Table 1 does not contain headers, but starts with the name of the method, e.g., MESSAGE, followed by the MESSAGE URI, e.g., “sip:userB@domain.com”, which is the destination address of the message. The current version of SIP used then follows, e.g., version 2.0. The next line of Table 1 displays the Via header, which also indicates the SIP version and transport mode, e.g., TCP, followed by the host name, e.g., “userA@domain.com”, of the originator of the message followed by the originator's port number, e.g., 5060. Each server that forwards the message enters its own forwarding address, e.g., “sipproxyA.domain.com” and “sipproxyB.domain.com”, to the header as well as its designated port number. Any responses as a result of the message then are able to follow the Via path, thus obviating the need for address resolution in the reverse direction.

Next, the To/From headers display the display name, e.g., UserB/UserA, and the URL of the destination/origination enclosed in brackets <>. The Call-ID header contains a unique identifier for the current call. All subsequent requests and responses during the call will contain the same unique identifier. CSeq represents the command sequence number of the current command, followed by the request method, e.g., MESSAGE. Each successive request or response will have a higher CSeq number, where the called and calling parties each maintain there own CSeq counts. The Content-Type, e.g., plain text, and finally the actual content, e.g., “Watson, come here.” and its length, 18, are supplied.

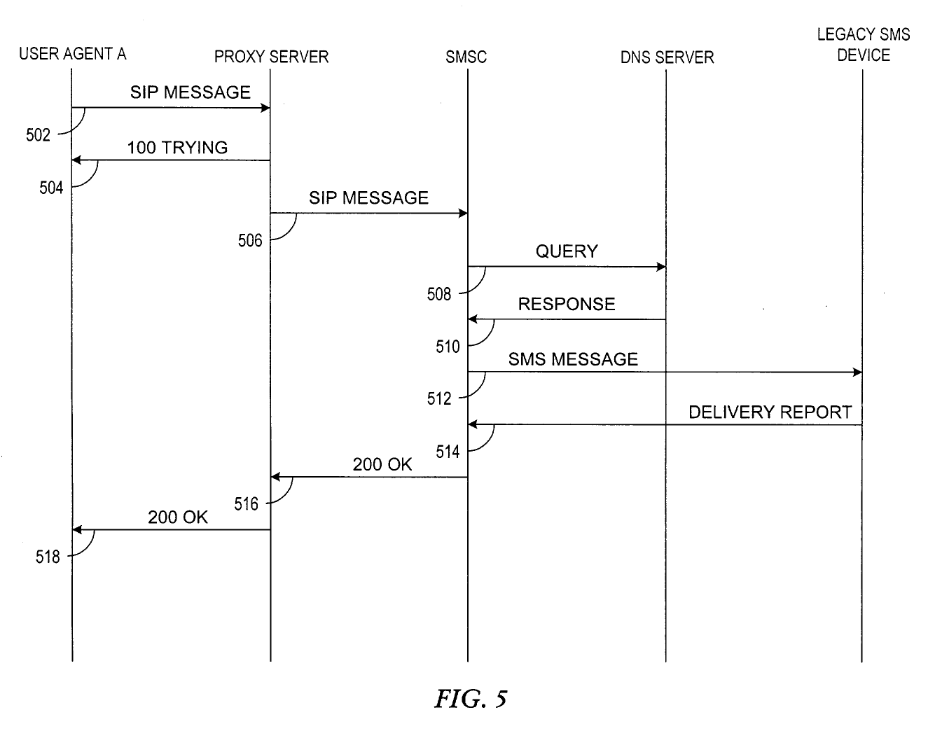

In another embodiment in accordance with the principles of the present invention, one of the devices in communication may not be a SIP enabled device, but rather a legacy SMS device. In such an instance, if the SIP enabled device knows that the recipient is not SIP enabled, but rather is a legacy SMS device, then procedures are put in place to make the appropriate translation from SIP to SMS as illustrated in FIG. 5.

The message flow diagram of FIG. 5 illustrates an exemplary SIP to SMS conversion message flow diagram according to one embodiment, where the originating terminal knows that the termination terminal is a legacy SMS device, but depends upon its SIP proxy to forward the SIP message to the serving SMSC for SIP to SMS translation. The message flows are explained in light of FIG. 1 and FIG. 3. User agent A, e.g., mobile terminal 302, wishes to send a SIP MESSAGE method to legacy SMS device, e.g., mobile phone 332 identified as UserB. In this example, mobile terminal 302 has cached the domain name served by SMSC 312 that was derived from an earlier message exchange and uses the cached domain name in its SIP message 502 to proxy server 304 via path 314. Proxy server 304 answers with “100 TRYING” message 504, via path 314, indicating that the request is progressing, but not yet complete.

The SIP MESSAGE is then sent to SMSC 312 in message 506, via path 316, for subsequent conversion from SIP to SMS format. The SMS conversion may be performed in a first embodiment by creating a new User Data Header (UDH) element and subsequently mapping all of the relevant SIP information received in message 506, such as originating device address and instant message body, into the new UDH. In an alternate embodiment, the relevant SIP information may be mapped into the SMS message body itself and then forwarded.

An example formation of an SMS UDH from a SIP message is illustrated in Table 2.

TABLE 2

| | VALUE | |
|---|---|---|
| UDH ELEMENT | (Hex) | SIP MESSAGE ELEMENT |
| Length of the UDH | 07 | N/A |
| Port Addressing - | 05 | N/A |
| 16 bit | | |
| Information Element | HH | Method MESSAGE |
| Information Element | 12 | Content-Length |
| Length | | |
| Destination Port | 13C6 | Via Header (port number 5062) |
| Source Port | 13C4 | Via Header (port number 5060) |

The first line of the UDH contains the length of the UDH, which includes the length of the actual message, followed by the bit resolution of the port addressing. The next line 10 contains the information element definition for a SIP MESSAGE method type having a value of “HH”, for example, where “HH” represents a hexadecimal representation of an unused information element identifier within the UDH construct. The length of the message follows, as well as the source and destination ports, e.g., 5062 and 5060, respectively, as derived from the Via header of the SIP message. The actual ASCII message is then transferred to the body of the SMS message.

SMSC 312 must first resolve the Mobile Station International ISDN Number (MSISDN) of legacy SMS device 332 prior to forwarding the SMS message to mobile phone 332. SMS 312 performs a QUERY in message 508 to resolve the MSISDN for legacy SMS device 332, i.e., UserB. The query may be delivered to any DNS agent 20 that contains the MSISDN map information for UserB, such as for example, the DNS service located within HSS 128. If legacy SMS device 332 has registered with the DNS service, then a positive response containing the MSISDN of legacy SMS device 332 is delivered in message 510. Once all addressing and message conversion has taken place, SMS message 512 is transmitted to legacy SMS device 332, via path 328, and in response, legacy SMS device 332 provides a delivery report to SMSC 312 in message 514, via path 328. SMSC 312 then responds with SIP response code “200 OK” in message 516 to proxy server 304, via path 316, who then forwards the SIP response code “200 OK” to SIP terminal 302 in message 518, via path 314.

It should be noted that SMSC 312 is serving as a terminating SIP node that performs message SIP/SMS conversion or SMS/SIP conversion depending upon the direction of message flow. For example, SIP messages may be converted to SMS messages for subsequent forwarding to an SMS receiving node as in message 506 and 512, respectively. Conversely, SMS messages received from and SMS transmitting node may be converted to SIP responses and forwarded to a SIP server proxy as in messages 514 and 516, respectively.

In another embodiment, mobile phone 332 may not support legacy SMS, but is rather an ALL-IP terminal with exclusive SIP functionality. In such an instance, the information placed into the UDH is needed for a SIP retry from mobile terminal 302 in the case of a SIP failure, since mobile phone 332 does not support SMS. In the retry phase, the SIP information is again needed by terminal 302, which it can derive from the previously configured UDH, and subsequently used for future SIP retries. In this case, SMSC 312 acts entirely as a SIP proxy server, whereby no SIP/SMS conversion is needed and SMSC 312 acts as a SIP forwarding node.

In another embodiment, mobile terminal 302 may be a legacy SMS device relaying an SMS message to SMSC 312 for subsequent delivery to mobile phone 332. In such a case, SMSC 312 may implement several message retry mechanisms in the event a first message delivery fails. For example, SMSC 312 may forward the message to mobile phone 332 via SMS and rely on SIP to support the message transmission retry mechanism. On the other hand, SMSC may convert the SMS message from mobile terminal 302 to a SIP message and then rely on SMS messaging to support transmission retries to mobile phone 332.

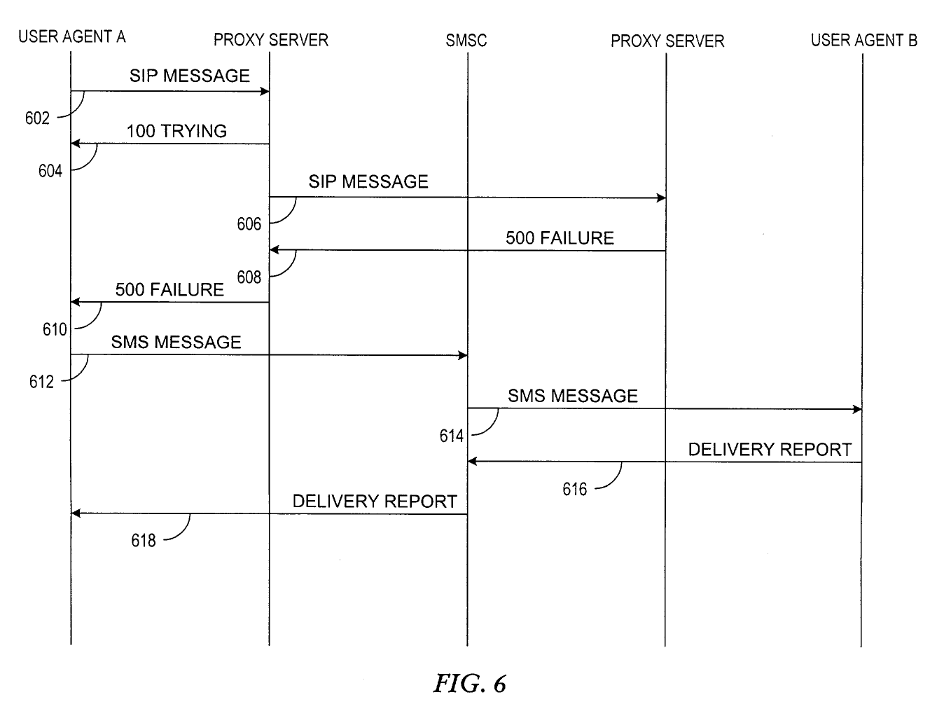

In another embodiment, mobile terminal 302 may be an ALL-IP device that also employs a legacy SMS stack, such that the message may be initiated as an SMS message directly from mobile terminal 302 in case of an original SIP failure. In this case, mobile terminal 302 provides an automatic fallback to legacy SMS by using the legacy SMS stack contained within mobile terminal 302 to forward the SMS message to SMSC 312 for storage and subsequent delivery as illustrated in FIG. 6.

FIG. 6 illustrates an exemplary SIP message flow between user agent A, an ALL-IP terminal employing a legacy SMS stack, and user agent B, an ALL-IP terminal employing a legacy SMS stack. It should be noted that all address resolution is assumed to have taken place as described, for example, in the message flow of FIG. 4 for SIP address translation and in the message flow of FIG. 5 for SIP/SMS address translation. User agent A initiates a MESSAGE method in message 602 to which “100 TRYING” response 604 is provided by user agent A's proxy server. The SIP message is forwarded to user agent B's proxy server in message 606, but results in a SIP response code of “500 FAILURE” in message 608.

Message 610 is received by user agent A which causes user agent A to automatically fall back to its legacy SMS stack in response to the SIP failure reported by message 610. In this instance, user agent A maps the relevant SIP information previously attempted in message 602 into an SMS UDH and maps the content of the SIP message to the SMS message body for subsequent forwarding to SMS message 612 to the SMSC. The SMS message is delivered in message 614 and the delivery is reported in the affirmative in message 616. Delivery report confirmation is provided to user agent A in message 618, due to user agent A's request for confirmation in the original SMS message 612.

In the event that delivery report 616 does not report an affirmative receipt by user agent B, one embodiment of the present invention allows SMSC to perform SMS delivery retry. In such an instance, the HLR/HSS/SGSN/other serving network element for user agent B may report that the “SMS teleservice is not supported/available/provisioned”, for example, or some other respective error code denoting a failed delivery attempt. If requested, the failed delivery attempt is reported to user agent A while the SMS retries are handled by the SMSC. The retry policy, for example, may be forwarded by user agent A to the SMSC in message 612. The retry policy may define the number of retries to perform upon failure, the amount of time allowed between retries, retry mechanism, e.g., SIP or SMS, etc. and may be embedded within the SMS UDH as well. In the case where a SIP retry is requested, SMSC may forward the retry request to a serving SIP gateway/proxy, which would then handle the SIP retry requests.

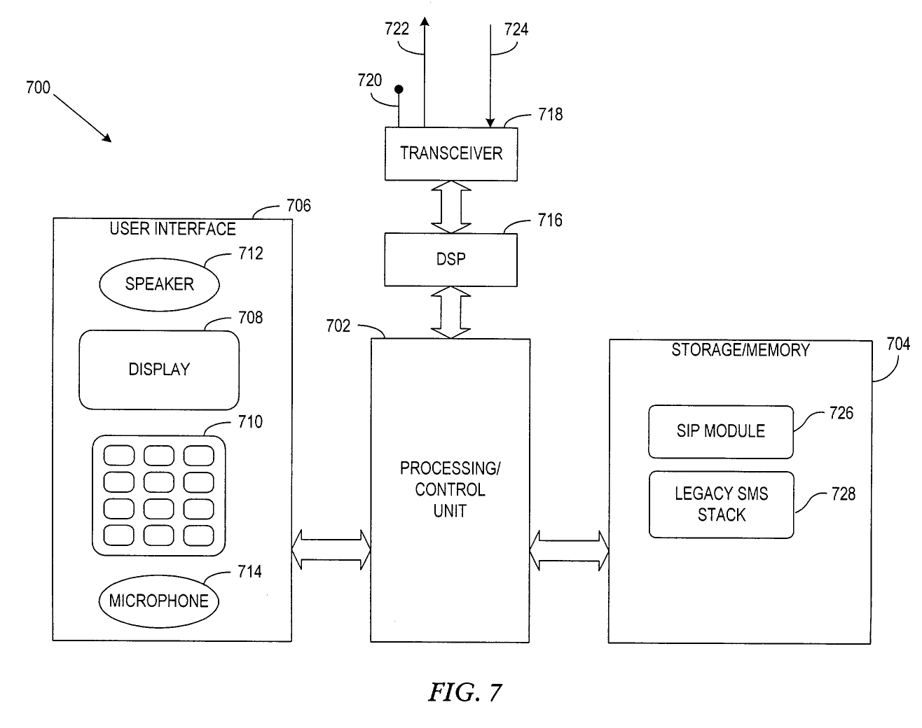

The invention is a modular invention, whereby processing functions within either a mobile terminal or an SMSC/SIP proxy may be utilized to implement the present invention. The mobile devices may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various SIP/SMS message retry functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for initiating/retrying SIP/SMS messaging functions in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by SIP module 726 and legacy SMS stack 728 available in the program storage/memory 704. Thus, the processing unit 702 is capable of initiating SIP/SMS messaging and retry functions associated with the present invention, whereby SIP messages may be issued by SIP module 726. SMS stack 728 may be invoked once notice of a failed SIP message delivery has been received by SIP module 726. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a messaging system and method in accordance with the present invention.

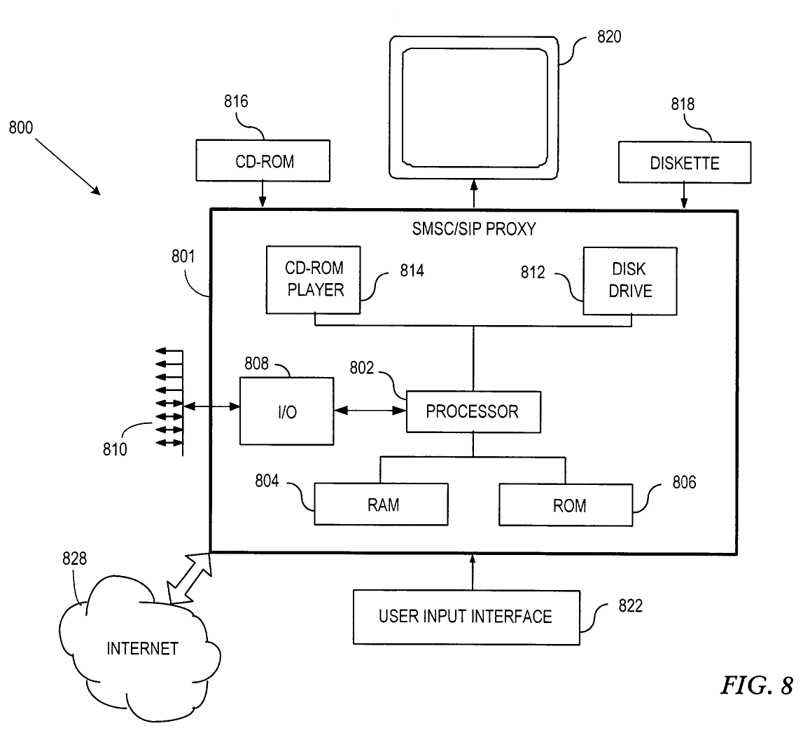

The network servers or other systems for providing SMSC/SIP proxy functions in connection with the present invention may be any type of computing device capable of processing and communicating digital information. The network servers utilize computing systems to control and manage the messaging activity. An example of a representative computing system capable of carrying out operations in accordance with the invention is illustrated in FIG. 8. Hardware, firmware, software or a combination thereof may be used to perform the various SMSC/SIP proxy functions and operations described herein. The computing structure 800 of FIG. 8 is an example computing structure that can be used in connection with such a messaging system.

The example computing arrangement 800 suitable for performing the messaging activity in accordance with the present invention includes SMSC/SIP proxy 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. For example, a SIP message such as that exemplified in Table 1 may be received by SMSC/SIP proxy 801 to enable delivery of the SIP message to the recipient, or conversely a retry of the SIP message in SMS format, as exemplified in Table 2. External data storage devices, such as DNS or location servers, may be coupled to I/O circuitry 808 to facilitate messaging functions according to the present invention. Alternatively, such databases may be locally stored in the storage/memory of the server 801, or otherwise accessible via a local network or networks having a more extensive reach such as the Internet 828. The processor 802 carries out a variety of functions as is known in the art, as dictated by software and/or firmware instructions.

SMSC/SIP proxy 801 may also include one or more data storage devices, including hard and floppy disk drives 812, CD-ROM drives 814, and other hardware capable of reading and/or storing information such as DVD, etc. In one embodiment, software for carrying out the messaging operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to SMSC/SIP proxy 801 via data signals, such as being downloaded electronically via a network, such as the Internet. SMSC/SIP proxy 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The SMSC/SIP proxy 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method for retrying a failed message delivery attempt, comprising:
transmitting a message of a first protocol type along a first transmission path;
receiving an indication of a failed delivery of the message;
converting the message of a first protocol type to a message of a second protocol type; and
transmitting the message of the second protocol type along a second transmission path.

2. The method according to claim 1, wherein transmitting the message of the first protocol type comprises:
resolving addresses of relay network elements along the first transmission path; and
maintaining a record of the resolved addresses.

3. The method according to claim 2, wherein the indication of the failed message delivery uses the record of resolved addresses to traverse the first transmission path.

4. The method according to claim 2, wherein converting the message of the first protocol type comprises:
transferring a portion of the resolved addresses from the message of the first protocol type to a header of the second protocol type; and
transferring a message content from the message of the first protocol type to a message content of the second protocol type.

5. The method according to claim 1, wherein transmission attempts of the message of the second protocol type occur until delivery is successful.

6. The method according to claim 1, wherein transmission attempts of the message of the second protocol type occur until a predetermined number of retries has occurred.

7. The method according to claim 1, wherein the first protocol type includes Session Initiation Protocol (SIP).

8. The method according to claim 1, wherein the second protocol type includes a protocol consistent with Short Messaging Service (SMS).

9. A messaging system, comprising:
a first terminal coupled to transmit a message in a first format;
a plurality of network elements coupled to relay the message; and
a second terminal coupled to receive the message, wherein a failed attempt to receive the message causes a retransmission of the message in a second format.

10. The messaging system according to claim 9, wherein the first terminal comprises:
a Session Initiation Protocol (SIP) stack as a primary means of communicating messages in the first format; and
a Short Messaging Service (SMS) stack as a secondary means of communicating messages in the second format.

11. The messaging system according to claim 10, wherein receipt of the failed message attempt in the first format causes the first terminal to retransmit the message in the second format.

12. The messaging system according to claim 9, wherein at least one of the plurality of network elements comprises:
a Session Initiation Protocol (SIP) stack as a primary means of communicating messages in the first format; and
a Short Messaging Stack (SMS) as a secondary means of communicating messages in the second format.

13. The messaging system according to claim 12, wherein receipt of the failed message attempt in the first format causes one of the at least one network elements to retransmit the message in the second format.

14. A mobile terminal wirelessly coupled to a network which includes a network element capable of relaying messages, the mobile terminal comprising:
a memory capable of storing at least one of a protocol module and a legacy module;
a processor coupled to the memory and configured by the protocol module to enable a message exchange of a first protocol type with the network element; and
a transceiver configured to facilitate the message exchange with the network element, wherein the processor is configured by the legacy module to exchange messages of a second protocol type in response to a failure of exchanges of messages of the first protocol type.

15. The mobile terminal according to claim 14, wherein usage of the protocol module and the legacy module is selected by the processor in response to messages received from the network element.

16. A computer-readable medium having instructions stored thereon which are executable by a mobile terminal for generating messages by performing steps comprising:
transmitting a message of a first protocol type along a first transmission path;
receiving an indication of a failed delivery of the message;
converting the first protocol type to a second protocol type; and
transmitting the second protocol type message along a second transmission path.

17. A server within a network used to facilitate an exchange of messages, comprising:
means for receiving messages of a first protocol type;
means for transmitting the messages to a network element;
means for receiving a receipt failure notification from the network element;
means for converting the first protocol type to a second protocol type in response to the receipt of failure notification; and
means for transmitting messages of the second protocol type to the network element.

18. The server according to claim 17, wherein the means for receiving messages of the first protocol type supports an ALL-IP core protocol compatible within a Third Generation (3G) network.

19. The server according to claim 18, wherein the first protocol type includes Session Initiation Protocol (SIP).

20. The server according to claim 19, wherein the messages of the first protocol type includes a retry policy.

21. The server according to claim 20, wherein the retry policy comprises fields to define at least one of: a number of retries to perform upon failure; an amount of time allowed between retries; and a retry mechanism.

22. The server according to claim 21, wherein the retry mechanism operates in accordance with a Short Messaging Service (SMS).

23. The server according to claim 17, wherein the means for receiving messages of the first protocol type supports a Short Messaging Service (SMS).

24. The server according to claim 23, wherein the messages of the first protocol type includes a retry policy.

25. The server according to claim 24, wherein the retry policy comprises fields to define at least one of: a number of retries to perform upon failure; an amount of time allowed between retries; and a retry mechanism.

26. The server according to claim 25, wherein the retry mechanism operates in accordance with a Session Initiation Protocol (SIP).

27. A computer-readable medium having instructions stored thereon which are executable by a network server for facilitating messaging by performing steps comprising:
receiving messages of a first protocol type;
transmitting the messages to a network element;
receiving a receipt failure notification from the network element; and
converting the first protocol type to a second protocol type in response to the receipt failure notification; and
transmitting messages of the second protocol type to the network element.
